(19) United States
(12) Patent Application Publication
(10) Pub. No.: US 2011/0248820 A1
(43) Pub. Date: Oct. 13, 2011

(54) DEVICE FOR AUTOMATICALLY UNLOCKING AN OPENABLE PANEL OF A MOTOR VEHICLE

(75) Inventor: Frederic Gehin, Creteil Cedex (FR)

(73) Assignee: VALEO SECURITE HABITACLE, Creteil Cedex (FR)

(21) Appl. No.: 13/121,753

(22) PCT Filed: Sep. 29, 2009
(86) PCT No.: PCT/EP2009/062604

§ 371 Date: May 10, 2011

(30) Foreign Application Priority Data
Oct. 1, 2008 (FR) 0805456

(51) Int. Cl. G05B 19/00

(52) U.S. Cl. 340/5.72

(57) ABSTRACT

The present invention relates to a device for automatically locking and/or unlocking at least one openable panel (3) of a motor vehicle (1) comprising a remote-opening system (4) comprising a central processing unit (5) designed to be installed inside the vehicle, and a portable identification element (17), said central processing unit (5) being capable of authenticating by radiofrequency the portable identification element (17). Said device further comprises means (13) for the remote optical recognition of a predetermined movement of part of the body for locking and/or unlocking said openable panel or panels in front of which the movement has been executed in the event of positive recognition of the movement and in that the central processing unit comprises activation means (11) for activating said remote optical recognition means (13) when the portable identification element (17) is located within a predefined perimeter (19) around the vehicle (1).

The present invention relates to a device for automatically unlocking an opening of a motor vehicle.

The device according to the invention applies, for example, to a vehicle equipped with a hands-free access system designed for a user of the vehicle to be able to enter into said vehicle without having to operate a key or a remote control.

Numerous hands-free access systems are currently being developed which ensure the unlocking/releasing and automatic opening of the openings of the vehicle as soon as the user wearing an identification badge approaches the vehicle within a predetermined perimeter. In this case, the predetermined perimeter consists of an external space surrounding the vehicle, for example at a distance from a few meters to possibly or so meters. In order to cover all of the predetermined perimeters, a large number of antennas are usually put in place, distributed at various points around the edge of the vehicle, in order to detect the presence of the identifier. Such antennas are, for example, arranged in the rear-view mirrors, the door handles and the door pillars. When the identifier is distant from this predetermined parameter, the system ensures the automatic locking-out of the openings of the vehicle.

More often than not, an approach sensor is coupled to the hands-free access system for an authentication attempt to be triggered only when the approach sensor detects the presence of a user. Thus, in the case where the authentication attempt is successful, the recognition device triggers the unlocking of one or more openings of the vehicle.

However, with the interactive systems, problems of unwanted unlocking of the openings are sometimes encountered. Simply the presence of the badge wearer within the environment of the vehicle is sufficient in fact to unlock the doors and it happens that the interchanges between the badge and the emission-reception unit of the vehicle order the unlocking of the doors without the user wishing to do so or being aware of it.

However, if the system unlocks all the openings of the vehicle, there is the risk of an ill-intentioned person approaching the vehicle in order, for example, to steal objects from the vehicle.

Moreover, a first-generation hands-free system that operates on the basis of a transponder technology is known from the patent application EP0770749 in the name of the Applicant.

The system described in this application can be used to open/unlock a determined opening without the direct intervention of the hands. However, it requires the user to hold a transponder in the hand and to present this transponder in front of the receiving antennas installed, for example, on the trunk to be able to trigger the unlocking/opening of the trunk.

Thus, if a crate is being carried in two hands, such an approach of the hand to the transponder antennas may prove rather difficult. Furthermore, given that the interchanges between the transponder and the receiving antennas are conducted over a short distance, the user needs to know fairly accurately the location of the antennas, which is not always the case, particularly in the case of a rental vehicle.

Moreover, the energy consumption associated with the automatic unlocking devices of the state of the art is often significant which may, when the vehicle is stopped with the motor off, cause the battery of the vehicle to discharge prematurely potentially preventing the vehicle from being started.

It is therefore an object of the present invention to overcome the abovementioned drawbacks in the state of the art and to provide a device for automatically unlocking an opening of the motor vehicle that optimizes the energy requirement and makes it possible to more generally overcome the fact of having to present an active identifier to a precise point of the vehicle in order to trigger the unlocking of the opening while retaining a high security level in order to prevent access by ill-intentioned persons.

Another object of the invention is to limit the battery consumption by optical recognition means by an improved triggering thereof.

To this end, the invention relates not only to the systems of hands-free access system type, but also to the door-opening devices based on one-way radio frequency transmission from a portable identification member to a computer located in the vehicle, such as a central processing unit.

To this end, the subject of the invention is a device for automatically locking and/or unlocking at least one opening of a motor vehicle comprising a remote opening system comprising a central processing unit intended to be installed inside the vehicle, a portable identification member, said central processing unit being capable of authenticating by radio frequency the portable identification member, characterized in that it further comprises optical means for remotely recognizing a predetermined movement of a part of the body to lock and/or unlock said at least one opening in front of which the movement has been executed in case of positive recognition of the movement, and in that the central processing unit comprises activation means for activating said remote optical recognition means when the portable identification member is located within a predefined perimeter around the vehicle.

According to a first embodiment, the activation means are controlled in response to the authentication of the portable identification member.

According to another embodiment, the remote opening system is a hands-free access system.

According to an additional embodiment, the central processing unit is configured to cyclically emit radio frequency signals in order to detect the presence of a portable identification member.

According to a supplementary embodiment, the radio frequency signals are low-frequency signals between 50 and 500 kHz.

According to another embodiment, the radio frequency signals are high-frequency signals between 50 and 500 MHz.

According to an additional embodiment, the central processing unit comprises means of estimating the distance between the vehicle and the portable identification member.

According to a supplementary embodiment, said means of estimating the distance between the vehicle and the portable identification member are based on the evaluation of the power of the radio frequency signal emitted by the portable identification member and received by the central processing unit.

According to another embodiment, said means of estimating the distance between the vehicle and the portable identification member comprise ultrasound transducers and are activated by the detection of the portable identification member around the vehicle.

According to a supplementary embodiment, the activation means of the central processing unit are configured to activate the remote optical recognition means when the portable identification member is, on the one hand, located within a predefined perimeter around the vehicle and, on the other hand, is approaching said vehicle.

According to an additional embodiment, the central processing unit comprises deactivation means for deactivating the remote optical recognition means after a predefined time.

According to another embodiment, the central processing unit comprises deactivation means for deactivating the remote optical recognition means after a predefined time from the locking and/or unlocking of at least one opening of the motor vehicle.

According to a supplementary embodiment, the portable identification member comprises a rechargeable battery.

According to an additional embodiment, the portable identification member comprises means of measuring the level of the battery and disabling means for disabling the emission of radio frequency signals intended to activate said remote optical recognition means if the level of the battery is below a predetermined level.

Other advantages and features will become apparent from reading the description of a nonlimiting embodiment of the invention, and from the appended drawings in which:

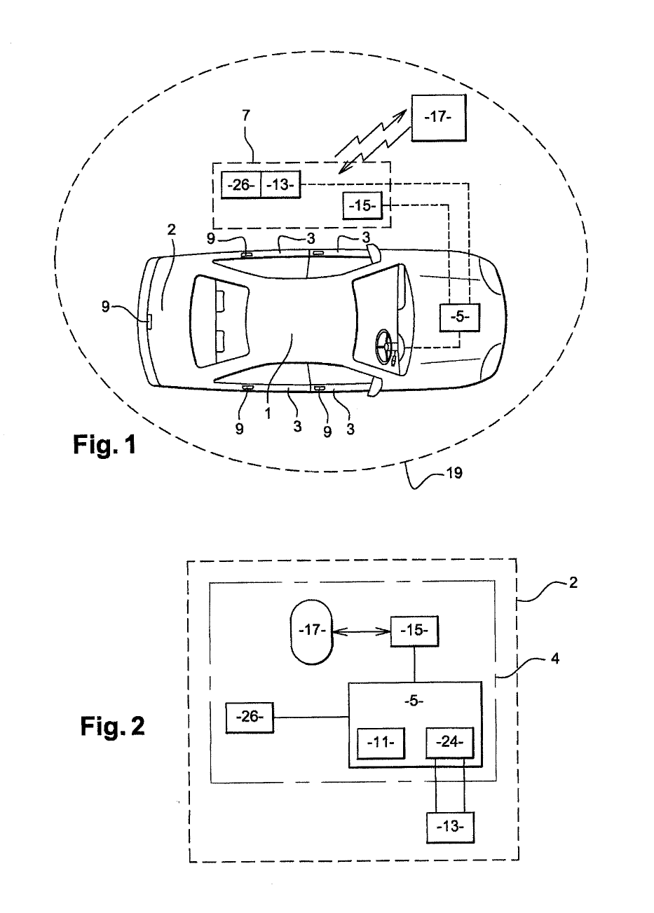

FIG. 1 is a plan view of a vehicle equipped with a device according to the invention,

FIG. 2 is a block diagram of the device according to the invention, and

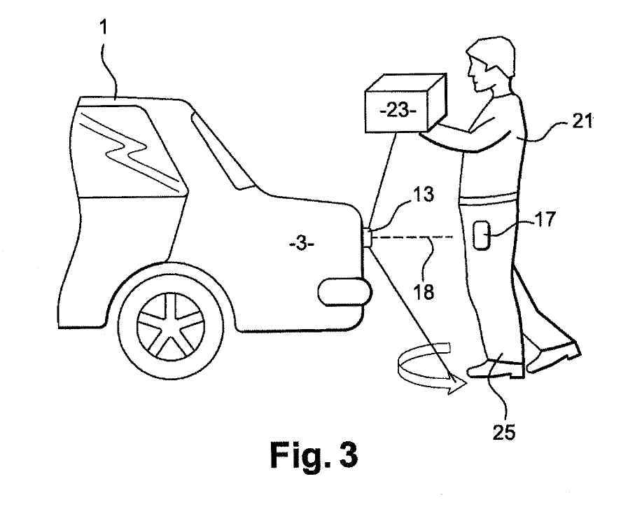

FIG. 3 is a side view of the vehicle of FIG. 1 with a user wanting to open the trunk of the vehicle.

There now follows a description of one embodiment of the invention with reference to FIGS. 1 to 3. In all the figures, identical elements are given the same reference numbers.

FIG. 1 shows a motor vehicle 1 equipped with a device 2 according to the invention for automatically locking and/or unlocking one or more openings 3 of the motor vehicle 1.

The term “opening” naturally covers the hinged or sliding side doors and the trunk or tailgate of the vehicle.

This device 2 according to the invention comprises a remote opening system 4 which may, for example, be a hands-free access system, said opening system comprising a central processing unit 5 intended to be installed inside the vehicle 1 which is linked to peripheral devices 7 installed, for example, on or in each handle 9. The term “handle” covers not only the door handles, but obviously that of a tailgate or of a trunk.

The peripheral devices 7 comprise, for example, remote optical recognition means such as a camera 13 to allow for the recognition of a predetermined movement of a part of the body of a user 21, in particular the movement of a foot, preferably the rotation of a foot, or the direction of rotation of a foot, and an emitter/receiver 15 to allow remote communication with a portable identification member 17 worn by the user 21 of the vehicle 1.

According to an alternative embodiment which is not represented, the use of an infrared sensor such as known from the document US2006/044800 can be envisaged to follow and recognize the movements of a user 21.

Obviously, the emitters/receivers 15 can also be arranged in other points of the vehicle independently of the handles, such as, for example, the roof of the vehicle or in the pillars or the bumpers.

Regarding the cameras 13, these may be black and white or color cameras. They are activated by activation means 11 located in the central processing unit 5 and are advantageously arranged so that the optical axis 18 is perpendicular to the lateral or rear planes of the vehicle 1 to avoid any masking effect with regard to the camera when facing the opening.

The portable identification member 17 is, for example, produced in the form of a badge and comprises means for radio communication with the emitter/receiver 15 linked to the central processing unit 5 to allow remote communication by radio frequency with the portable identification member 17. This communication may be performed by high-frequency waves, that is, waves between 50 and 500 MHz, or by low-frequency waves, that is, waves between 50 and 500 kHz depending on the equipment selected. The values generally used are 125 kHz for the low-frequency waves and 343 or 423 MHz for the high frequencies.

This communication is used in particular to authenticate the portable identification member 17, that is to say, to verify that said member 17 is indeed associated with the vehicle 1.

The authentication is triggered when the portable identification member 17 is detected within a predefined perimeter 19 around the vehicle 1.

The form of the perimeter 19 is in the present case an ellipse, but obviously, other forms can also be envisaged.

Moreover, the portable identification member 17 comprises, as energy source, a battery or an accumulator cell and preferably means of determining the energy level of this source. Furthermore, the optical recognition of a predetermined movement of a part of the body in order to allow for the automatic opening of an opening 3 of the motor vehicle 1 as described in the present invention may be considered as a convenience function. Thus, in the case where the energy level of the battery or of the accumulator cell of the identification member 17 is below a predetermined value, said convenience function is disabled in order to conserve the energy available for the essential functions such as the unlocking by remote control of the openings 3 of the vehicle 1, for example.

According to an alternative embodiment, the portable identification member 17 has, on the one hand, a backup battery and, on the other hand, a rechargeable battery. The so-called “convenience” functions such as the automatic unlocking of an opening 3 described in the present invention being powered only by the rechargeable battery. The backup battery provides power for the basic functions such as the opening by remote control of the openings when the rechargeable battery is discharged. Thus, the basic functions of the portable identification member 17 can always be assured regardless of the level of the rechargeable battery.

Moreover, when the level of the battery of the portable identification member 17 is below a predetermined level, said identification member 17 can send a signal to the vehicle indicating that the level of its battery is low. In response to this message, the vehicle can then stop trying to communicate with said identification member, thus making it possible to optimize the vehicle battery consumption. A new signal being sent to the vehicle when the level of the battery of the portable identification member 17 once again rises above the predetermined level in order to restore communications between the vehicle and said identification member 17.

In a preferred embodiment, the vehicle comprises means of measuring the level of charge of the battery of the vehicle, that are capable of comparing this level with a reference level. These means, for example, comprise the central processing unit 5. When the charge level of the battery drops below the reference level, the central processing unit 5 then orders the present camera start functionality to stop.

To this end, the central processing unit 5 causes the functions for interrogating the identification module and/or for receiving and recognizing a signal coming from this identification module, and specifically intended to start the camera, to be stopped.

With such a disabling of the processing, which takes place in the vehicle and is intended to start up the camera, a portion of the consumption applied to the battery of the vehicle is cancelled and the remaining life of the battery is extended.

We will now look more particularly at FIG. 3 to describe the operation of the device according to the invention.

FIG. 3 shows a user 21 carrying a portable identification member 17 in a pocket and loaded with an object 23 that he wants to place in the trunk 3 of the vehicle 1.

Firstly, the presence of the portable identification member 17 is detected within the predefined perimeter 19 around the vehicle 1.

The detection of a member 17 will, in the central processing unit 5, wake up an access computer which uses radio communication to authenticate the portable identification member 17 to check that the latter is indeed associated with the vehicle 1.

In case of negative authentication, the scanning continues in order to detect the presence of an identification member 17 within a perimeter 19.

In case of positive authentication, the remote opening system 4 is placed in a “ready to unlock” state for all the openings.

Alternatively, in case of positive detection, the distance separating the portable identification member from the vehicle is determined and the remote opening system 4 is placed in a “ready to unlock” state for all the openings 3 when this distance is below a predetermined value, 5 meters for example.

Preferably, in order to avoid the unwanted activation of the “ready to unlock” state when the portable identification member 17 is stored in proximity to the vehicle 1, a condition of approach of said member 17 toward the vehicle 1 is essential to the activation of the “ready to unlock” state.

The measurement or estimation of the distance between the portable identification member 17 and the vehicle 1 is performed by measuring or estimating the power of the received signals and by comparing this power to a database comprising the values of the powers of the signals emitted by the portable identification member 17 and received by the emitters/receivers 15 according to the distance separating them.

Alternatively, the distance between the portable identification member 17 and the vehicle 1 can be determined using ultrasound transducers, the latter being activated when said portable identification member 17 is detected.

The “ready to unlock” state results in the activation, by virtue of the activation means 11, of the cameras 13 which begin to record images. The optical means 13, 24 for remotely recognizing a predetermined movement of a part of the body, notably the camera, are therefore only activated after a positive authentication or when the distance between the portable identification member 17 is a short distance from the vehicle 1, which allows for an optimized management of the energy of the battery of said vehicle 1.

Preferably, firstly, the opening in front of which the user 21 is located is identified via the cameras 13 and an image processing computer 24 in the central processing unit 5.

Once the central processing unit 3 has determined the opening concerned, the cameras associated with the other openings stop recording images to free up processing capacity for the image processing computer 24.

Alternatively, an approach sensor 26 is also placed in the handle 9 or in proximity to the latter to activate only the camera of the opening 3 concerned.

In the present example, the opening concerned 3 is the trunk of the motor vehicle 1 (see FIG. 3).

A predetermined movement of a part of the body is then remotely recognized optically by the camera 13. This step of remote optical recognition by a camera of a predetermined movement of the part of the body is preferably performed on the basis of gray level images to optimize the capacity/cost pairing of the image processing computer 24.

It has proven wise to be able to recognize the movement of a foot 25, in particular the rotation of movement or the direction of rotation of the foot 25 of the user 21. In practice, the movement of a foot is discrete while being clearly recognizable for the camera and the image processing computer.

In case of positive recognition of the movement, the opening 3 in front of which the movement has been executed, is unlocked, that is to say, the lock is unlocked.

If the trunk is equipped with suitable springs automatically urging it toward an open position, then the trunk is opened.

In the case where the opening 3 is equipped with a motor-driven unit for assisting in the opening of the opening (not represented), there follows an automatic opening of the opening 3 via the motor-driven assistance unit.

It will therefore be understood that, by virtue of the features of the invention, the user can easily and securely access his vehicle. The system is also differentiated by an optimized management of the energy consumption given that the device is activated only when the user is in immediate proximity to the vehicle.

The exemplary embodiments described hereinabove for the opening of a motor vehicle opening are, in a variant, applied to the closing of an opening, with the same steps and the same means, for example.

The central processing unit advantageously identifies the open/closed state of the opening at the very moment when the same steps are implemented, and respectively triggers the closing or the opening of the opening depending on its respective open or closed state.

The opening that can be controlled by virtue of the means described is not limited to a motor vehicle trunk lid. It may consist of a side door, a window, an opening roof or any other type of opening suited to a vehicle of a type known per se.

For example, the present means may be implemented in the context of the invention for the locking and/or the unlocking and/or for the motor-driven opening or closure of a number of openings simultaneously.

The invention applies, for example, to the closing and/or opening of the windows of the vehicle with the opening roof of this same vehicle, simultaneously.

1. A device for automatically locking and/or unlocking at least one opening of a motor vehicle comprising:
a remote opening system comprising a central processing unit intended to be installed inside the vehicle;
a portable identification member,
said central processing unit being capable of authenticating by radio frequency the portable identification member; and
optical means for remotely recognizing a predetermined movement of a part of the body to lock and/or unlock said at least one opening in front of which the movement has been executed in case of positive recognition of the movement, and in that the central processing unit comprises activation means for activating said remote optical recognition means when the portable identification member is located within a predefined perimeter around the vehicle.

2. The device as claimed in claim 1, wherein the activation means are controlled in response to the authentication of the portable identification member.

3. The device as claimed in claim 1, wherein the remote opening system is a hands-free access system.

4. The device as claimed in claim 1, wherein the central processing unit is configured to cyclically emit radio frequency signals in order to detect the presence of a portable identification member.

5. The device as claimed in claim 4, wherein the radio frequency signals are low-frequency signals between 50 and 500 kHz.

6. The device as claimed in claim 4, wherein the radio frequency signals are high-frequency signals between 50 and 500 MHz.

7. The device as claimed in claim 1, wherein the central processing unit comprises means for estimating the distance between the vehicle and the portable identification member.

8. The device as claimed in claim 7, wherein said means for estimating the distance between the vehicle and the portable identification member are based on the evaluation of the power of the radio frequency signal emitted by the portable identification member and received by the central processing unit.

9. The device as claimed in claim 7, wherein said means for estimating the distance between the vehicle and the portable identification member comprise ultrasound transducers and are activated by the detection of the portable identification member around the vehicle.

10. The device as claimed in claim 8, wherein the activation means of the central processing unit are configured to activate the remote optical recognition means when the portable identification member is located within a predefined perimeter around the vehicle and is approaching said vehicle.

11. The device as claimed in claim 1, wherein the central processing unit comprises deactivation means for deactivating the remote optical recognition means after a predefined time.

12. The device as claimed in claim 1, wherein the central processing unit comprises deactivation means for deactivating the remote optical recognition means after a predefined time from the locking and/or unlocking of said opening of the motor vehicle.

13. The device as claimed in claim 1, wherein the portable identification member comprises a rechargeable battery.

14. The device as claimed in claim 13, wherein the portable identification member comprises means of measuring the level of the rechargeable battery and disabling means for disabling the emission of radio frequency signals intended to activate said remote optical recognition means if the level of the rechargeable battery is below a predetermined level.
